(19) United States
(12) Patent Application Publication
(10) Pub. No.: US 2012/0256751 A1
(43) Pub. Date: Oct. 11, 2012

(54) Talking Power Management Utility

(76) Inventors: Madhu Nallabelli, Troy, MI (US); Dean Figlioli, Royal Oak, MI (US)

(21) Appl. No.: 13/438,060

(22) Filed: Apr. 3, 2012

Related U.S. Application Data
(60) Provisional application No. 61/473,297, filed on Apr. 8, 2011.

(51) Int. Cl. G08B 21/00

(52) U.S. Cl. 340/636.1

(57) ABSTRACT

An architecture is presented that provides a computer-implemented system and method for monitoring a remaining battery charge level in a device and detecting when said battery charge level is reduced to a selected level. The system comprises a monitoring component that monitors remaining battery charge levels for any device that requires power management. The monitoring component can monitor all types of batteries as is known in the art. Further, the monitoring component communicates with a detection component which detects when the battery charge levels of the devices are low and/or reach a predetermined threshold level. The system further comprises a trigger component that sends a customizable alert to a user once a low battery charge level and/or a predetermined threshold level has been reached. Furthermore, the system comprises a power component that automatically places the device in standby mode after a predetermined period of time after the alerts are sent.

### CROSS-REFERENCE

This application claims priority from Provisional Patent Application Ser. No. 61/473,297 filed Apr. 8, 2011.

### BACKGROUND

Individuals and companies currently rely heavily on electronic devices to function on a daily basis, and reliance on said devices is expected to continue to grow in the future. Many of said electronic devices rely upon batteries, such as lithium batteries and the like, as their primary power source, and the field of power management with respect to said batteries is becoming increasingly important. Currently companies and other businesses are moving towards a more electronic methodology as it relates to servicing their customers and business needs. However, these same companies and businesses are struggling with the required power management needed for these electronic tools.

Current power management tools directed at alerting a user of a depleted battery tend to irritate users with loud buzzers and/or alarms. These loud buzzers and/or alarms are simply muted, unplugged, and/or ignored while the electronic device is left untended and depleted. Thus, the battery of the electronic device remains uncharged, and continues to deplete. Typically, when the battery of the electronic device completely runs out, all content, such as music, videos, podcasts, photos, applications, emails, etc. is interrupted on the device, and the device goes into a non-functional mode. Consequently, the battery for the device must be charged for a period of time before the device can be used. Allowing the battery of an electronic device to deplete completely on a repeated basis tends to shorten the life of the battery, and typically causes the need to replace the battery. These types of issues impact the number of tools needed to service the customer, company, or business and can increase the risk of security and possible loss of revenue. Consequently, an effective solution is necessary.

There is a need for an improved system and method for monitoring remaining battery charge levels and detecting when battery charge levels are low. The present invention discloses a Talking Power Management Utility (TPMU) program for monitoring remaining battery charge levels and placing the device in standby mode when the device's remaining battery charge level is low. The TPMU program instructs an electronic device with a depleted battery to enter into a standby mode, effectively elongating the life of the battery and reducing cost for replacement. This hardware and/or software solution also detects the battery charge levels and alerts the user proactively with a soothing, customizable audible alert. These alerts can be applied to any electronic device that requires power management and will work in conjunction with any type of battery. This product is ideal for use in administrative, medical, and home settings in devices that require power management. The TPMU program provides users with an efficient device and method for monitoring remaining battery charge levels and detecting when battery charge levels are dangerously low.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a computer-implemented system and method for monitoring remaining battery charge levels and detecting when battery charge levels are low. The system comprises a monitoring component that monitors remaining battery charge levels for any electronic device that requires power management. The monitoring component can monitor all types of batteries as is known in the art. Further, the monitoring component communicates with a detection component. The detection component detects when the battery charge levels of the devices are low and/or reach a predetermined threshold level. The system further comprises a trigger component that sends an alert to a user once a low battery charge level and/or a predetermined threshold level has been reached. The alert is customizable by a user, and alerts the user proactively with a soothing message.

Furthermore in the preferred embodiment of the present invention, the system comprises a power component that automatically places the device in standby mode after a predetermined period of time after the alerts are sent to a user. Additionally, the monitoring component and the detection component of the system comprise a software program and/or hardware to enable the components to recognize all batteries from various stationary and mobile devices requiring power management, to monitor and detect the battery charge level on these devices, and to alert a user of these battery charge levels via audio/video message alerts.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a computer-implemented system for monitoring remaining battery charge levels and detecting when battery charge levels are low in accordance with the disclosed architecture.

FIG. 2 illustrates a logical flowchart of the system for monitoring remaining battery charge levels and detecting when battery charge levels are low in accordance with the disclosed architecture.

FIG. 3 illustrates a technical flowchart of the system for monitoring remaining battery charge levels and detecting when battery charge levels are low in accordance with the disclosed architecture.

FIG. 4 illustrates a software flowchart of the system for monitoring remaining battery charge levels and detecting when battery charge levels are low in accordance with the disclosed architecture.

FIG. 5 illustrates a computer-implemented method for monitoring remaining battery charge levels and detecting when battery charge levels are low in accordance with the disclosed architecture.

FIG. 6 illustrates a block diagram of a computing system operable to execute the monitoring and detecting system in accordance with the disclosed architecture.

FIG. 7 illustrates an exemplary computing environment operable to provide support for the monitoring and detecting system.

FIG. 8 illustrates a TPMU hardware block diagram of the system for monitoring remaining battery charge levels and detecting when battery charge levels are low in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention discloses a Talking Power Management Utility (TPMU) program for monitoring remaining battery charge levels and placing a device in standby mode when the device's remaining battery charge level is low. The TPMU program allows a device to enter the standby mode gracefully, effectively elongating the life of the battery and reducing the cost for replacement. This hardware and/or software solution also detects the battery charge levels and alerts the user proactively with a soothing, customizable audible alert. These alerts can be applied to any device that requires power management and will work in conjunction with any type of battery. This product is primarily intended for use in administrative, medical, and home settings, with any device that requires power management.

The disclosed invention comprises a computer-implemented system and method for monitoring remaining battery charge levels and detecting when battery charge levels are low. The system is comprised of a hardware/software program that has the ability to read all batteries and their respective charging levels on any device requiring power management, and alerting a user of those levels via audio/video message alerts. Specifically, the system sends an alert to a user once a low battery charge level and/or a predetermined threshold level has been met and if the user does not respond and charge the device, the device will automatically enter a standby mode.

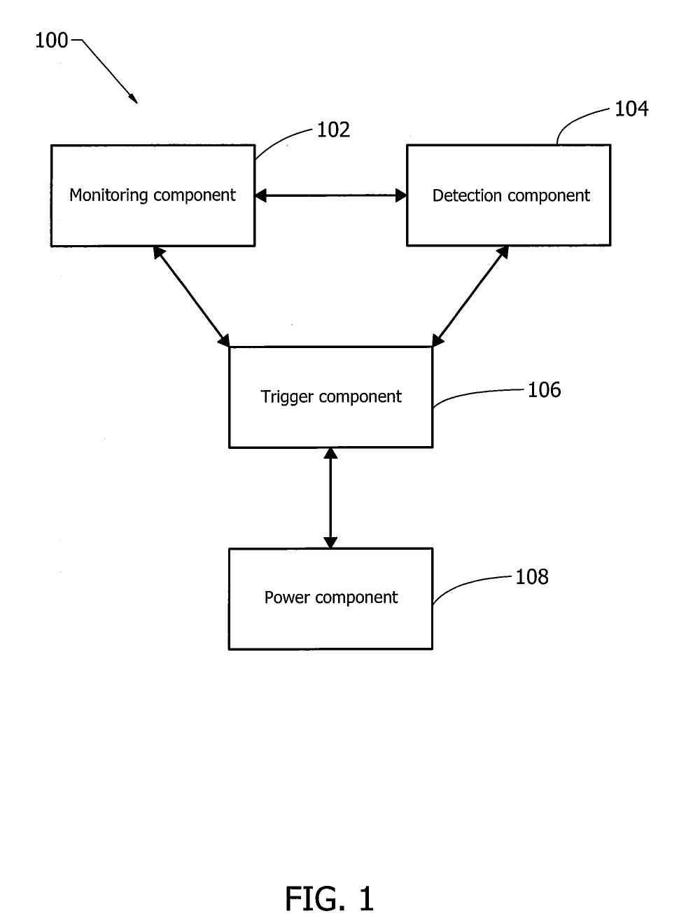

Referring initially to the drawings, FIG. 1 illustrates a computer-implemented system for monitoring a remaining battery charge level in a device and detecting when said battery charge level is reduced to a selected level 100. The system 100 comprises a monitoring component 102 that monitors the battery charge levels for any device that requires power management. The monitoring component 102 can monitor all types of batteries, such as lithium ion or cadmium nickel, or any other type of battery as is known in the art without affecting the overall concept of the invention. The monitoring component 102 monitors the battery charge levels of all types of batteries for devices, such as smart phones, laptops, tablets, iPods, etc., as is known in the art without affecting the overall concept of the invention. Further, the monitoring component 102 communicates with a detection component 104. The detection component 104 detects when the battery charge levels of the devices are equal to or less than the selected level. Typically, the selected battery charge levels are approximately between 0-30%, more preferably approximately 30%. Additionally, the detection component 104 can be programmed to detect battery charge levels at different levels, and/or to detect battery charge levels at a predetermined threshold level. For example, the detection component 104 can detect a weak battery and start alerting a user when approximately 50% of the battery charge is left. The detection component 104 can also detect a stronger or newer battery and start alerting a user when approximately 40% of the battery charge is left. However, for both weak or strong batteries, the detection component 104 detects the battery charge level and places the device in a standby mode when approximately 30% of the battery charge is left.

Furthermore, there are two types of monitoring solutions (a hardware solution and a software solution) that will monitor battery charge levels depending on the type of battery and the unit in which the battery is used. Specifically, the hardware solution will monitor any type of rechargeable or non-rechargeable battery that uses “no” inverter on the device. A hardware electronic circuit (described more fully below) is connected to the terminals of the battery. The electronic circuit collects the current amperes from the battery and calculates accurate charge levels to output warnings. The software solution monitors any type of rechargeable battery using all types of inverters installed on devices. The inverter provides a feedback signal with information about the remaining battery charge level and source of power (i.e., AC or Battery). This feedback data is analyzed by the monitoring component 102 and submitted to the detection component 104 for output warnings (alerts). The monitoring component 102 also monitors when the power (AC) is resumed and as soon as the power is resumed, the monitoring component 102 wakes up the device from standby mode to normal operation mode.

Based on the battery charge levels provided by the monitoring component 102, the detection component 104 will check if the device is in use or not by a user. For example, if the battery is weak or older the detection component 104 checks the threshold of remaining battery charge (RBC) and when RBC equals approximately 50%, and alert is emitted to the user. The alert includes an audio and/or voice alert and/or displaying a visual pop-up with an animated character. During this example, alerts will repeat every 1 minute until the RBC is approximately 35% or less. When the RBC equals approximately 35%, a two minute warning to put the device into standby mode is displayed. When the RBC equals approximately 30%, the device will be gracefully placed into standby mode.

In another example, if the battery is stronger or new and in use by a user the detection component 104 checks the threshold of remaining battery charge (RBC) and when the RBC equals approximately 40%, a first alert is emitted. The alert includes playing audio and/or a voice alert with no visual pop-up or animated character since the device is currently in use. During this example, alerts will repeat every one minute until the RBC is approximately 35% or less. When the RBC equals approximately 35%, a two minute warning to put the device into standby mode is displayed. When RBC equals approximately 30%, the device will be gracefully placed into standby mode.

The system 100 further comprises a trigger component 106 that sends an alert to a user once the battery charge level is equal to or less than the selected level. The alert is customizable by a user, and alerts the user proactively with a soothing message. The alerts can be audio message alerts, video message alerts, or both audio and video message alerts. For example, the audio message alerts can be accompanied by video animations. The message alerts provide voice messages when needed and are based on user requirements. When a device meets a threshold condition the software detects if the device is in use by a user and if “yes” only a soothing audio voice alert message is played warning the user that the battery is getting low. If the device is “not” in use, both an audio or a voice message and a pop-up display message with animated characters will be played on the screen. For example, animated characters will perform gestures on the device depending on the type of audience. Specifically, children could see a racing car move across the screen, a smiley bouncing ball, etc. For adult users it could be a picture showing a power plug being plugged into an electrical outlet, etc. The system permits characters and voices to be customized by gender and user.

Furthermore, the audio or voice messages are produced by a variety of customized pre-recorded voice message audio clips. These audio clips can be language and gender specific. Typically, the audio clips are software files provided within the software system or the audio clips can be stored pro-grammatically on a chip in case of a hardware system. Additionally, these message alerts can be applied to any device that requires power management and will work in conjunction with any type of battery.

Further, the system 100 comprises a power component 108 that places the device in a standby mode after a predetermined period of time. The power component 108 will execute a command when the battery charge criteria is met, placing the device into a standby mode by using manufacturer's specifications from the device. The power component 108 also detects when power has been restored (i.e., device plugged in), thus waking the device up.

Specifically, the trigger component 106 sends an alert to a user once a low battery charge level and/or a predetermined threshold level has been met and if the user does not respond and charge the device, the power component 108 will gracefully place the device in a standby mode, effectively elongating the life of the battery and reducing the cost of replacing the battery. Typically, once the trigger component 106 sends an alert to a user, a predetermined period of time passes and then the power component 108 automatically places the device in a standby mode.

Furthermore, the monitoring component 102 and the detection component 104 of the system 100 comprise a software program (TPMU software) and/or hardware (TPMU hardware) to enable the monitoring component 102 and the detection component 104 to recognize all batteries from various stationary and mobile devices requiring power management, and to monitor and detect the battery charge level on these devices, and to alert a user of these battery charge levels via audio/video message alerts. Specifically, a software program can be utilized to monitor the battery charge levels and trigger the message alert. The software program comprises middle ware that communicates with the stationary or the mobile device to capture specific battery charge levels and trigger the message alert. Alternatively, or in addition to, hardware can be utilized to monitor the battery charge levels and trigger the message alert. The hardware comprises a microchip programmed with a software program which monitors the battery levels and triggers message alerts.

The TPMU software (Client) program performs the following functions: the software program collects the remaining battery charge (RBC) from the “TPMU hardware” or from the inverter if one exists. The software program determines the source of power to the device (DC or AC) from the “TPMU hardware” or from the inverter if one exists. The software program generates various alerts audio, visual, animated characters etc. based on the different threshold RBC values. The software program senses the usage of the device based on user activity. The software program places the device into standby mode when RBC is below the threshold value of approximately 30%. The software program wakes up the device when the power is resumed.

The software program is smart to compliment the user when user responds to the alerts and takes necessary action of plugging in the device to electrical outlet. For example, the software automatically detects a change in the power source going from battery to AC (electrical outlet) and senses when a user is following or reacting to the recommended power management messages being given on the device. When the user follows the required power management messages or responds to the messages by plugging the device in, the user will receive an audio voice message, such as “Thank you for plugging the device in”. Furthermore, the software program warns the user if device is unplugged without being fully charged. The software program provides a battery charge level indicator that helps the user to select the devices for use when the charge is full.

Additionally, the software program provides a tool for the user to get the specifications, statistics and details of the device. The software program provides a graphical view of the battery charge levels for the past period of time (i.e., up to 90 days). The software program self-repairs itself in case of corruption. The software program determines if the battery is strong or weak based on the history of charge and discharge cycles.

Furthermore, the TPMU software is designed to work on a single stand-alone device for a home user or a business user. The software is also designed to work on an iPhone or other smart phone. If the software is implemented in a business or corporation on multiple devices a “TPMU Server Software” is developed which then installs on a Windows® (or similar type) server using an SQL server as the database. All the client devices communicate with the server to send and receive data for installation, configuration, customization, patching, reporting purposes and also to maintain licenses.

Features of the TPMU Server Software include: groups the devices based on physical location or department; allocates the devices based on IF addresses to groups; applies the configuration policies to the devices based on the following specifications; visual and audio voice message alerts (which are configurable with, but not limited to, adult male or adult female or child voice, duration of alert, beeps, alert repeat intervals, or modifying visual text); volume control (user customizable audio level); batteries (user selection of number of batteries which includes internal and external batteries); power save (use customizable settings for saving power by placing the device in standby mode when not in use); dormant (placing the devices un-used for a long period, which is customized by a user, into a dormant state and removing them from a database after a very long extended period in the dormant state; license (maintaining and sending warnings to administrators about licensing related information); and TPMU Server software categorizes the devices into online devices, offline devices, standby devices and alerting devices.

The software also keeps track of device status relating to alerts and battery usage, etc. and stores the information in a database. This information is later used for generating custom reports. The software interfaces with call center software to automatically open tickets via HL7, SQL and VBScripts and sends escalation emails, text messages, or pager messages. The software interfaces with the helpdesk or call center software to open trouble tickets or issues based on the escalation situation. The server communicates with the client software and collects data from the client related to RBC and power sources and stores the data in the database. Further, the client sends critical information about when the device was placed in standby mode and when it was woken up from standby mode to the server. The software displays information on a dash board. The information includes categorizing devices by geographical locations, specific details related to each device's usage and current battery status. The software can also run reports related to financial, device usage, and current battery status.

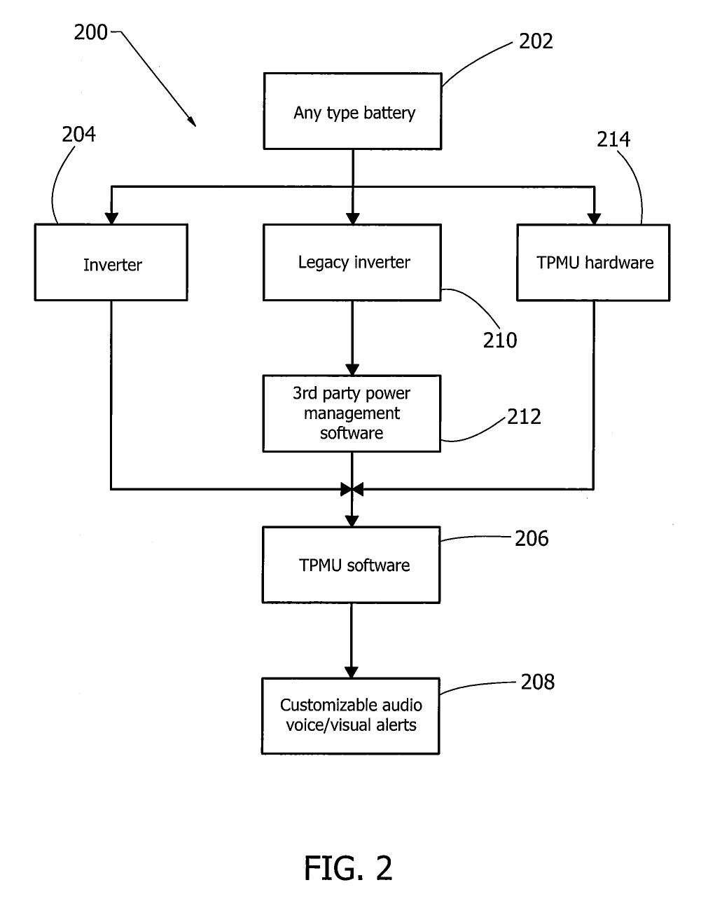

FIG. 2 illustrates a logical flowchart of the system 200 for monitoring remaining battery charge levels and detecting when battery charge levels are low. At 202, any type of battery is recognized from either a stationary or a mobile device requiring power management. Specifically, the software program uses an internal database which consists of various manufacturers, device model numbers and the battery types used in mobile devices. Battery type is detected based on the data in database. This database is updated periodically via upgrades or patches and/or firmware updates. Then at 204, an inverter is contacted to change the battery to a recognized power supply, i.e., battery or alternating current (AC). The software program monitors and uses the inverter created by the manufacturer of the device. The inverter has two functions that the software compiles from. First, the software compiles and converts the DC voltage to AC, and second the software compiles and provides the remaining battery charge level of the internal battery of the device such that the message alerts can be sent to the user when a specific criteria is met.

Once the battery is recognized, at 206 a software program that comprises middle ware communicates with the stationary or the mobile device to capture specific battery charge levels and trigger a message alert. At 208, if a low battery charge level and/or a predetermined threshold level has been met, a customizable audio, voice/visual message alert is sent to a user. The message alert can be audio message alerts, video message alerts, or both audio and video message alerts. For example, the message alerts are customizable audio/voice alerts with or without animated characters.

Additionally, to support some legacy inverters 210 that do not provide a feedback signal regarding RBC and the power source of the device to the TPMU Software, a third party program 212 (i.e., 3^{rd} Party Power Management Software) that can talk to the legacy inverter 210 is used as a middleware. This middleware program is interfaced with the TPMU Software 206 to collect the RBC and power source values and trigger a message alert. At 208, if a low battery charge level and/or a predetermined threshold level has been met, a customizable audio, voice/visual message alert is sent to a user.

Finally, hardware instead of software can be utilized to monitor the battery charge levels and trigger the message alert. At 214, hardware that comprises a microchip programmed with a software program which monitors the battery levels and triggers message alerts is utilized. Specifically, at 206, the software program programmed in the microchip comprises middle ware that communicates with the stationary or the mobile device to capture specific battery charge levels and trigger a message alert. At 208, if a low battery charge level and/or a predetermined threshold level has been met, a customizable audio, voice/visual message alert is sent to a user.

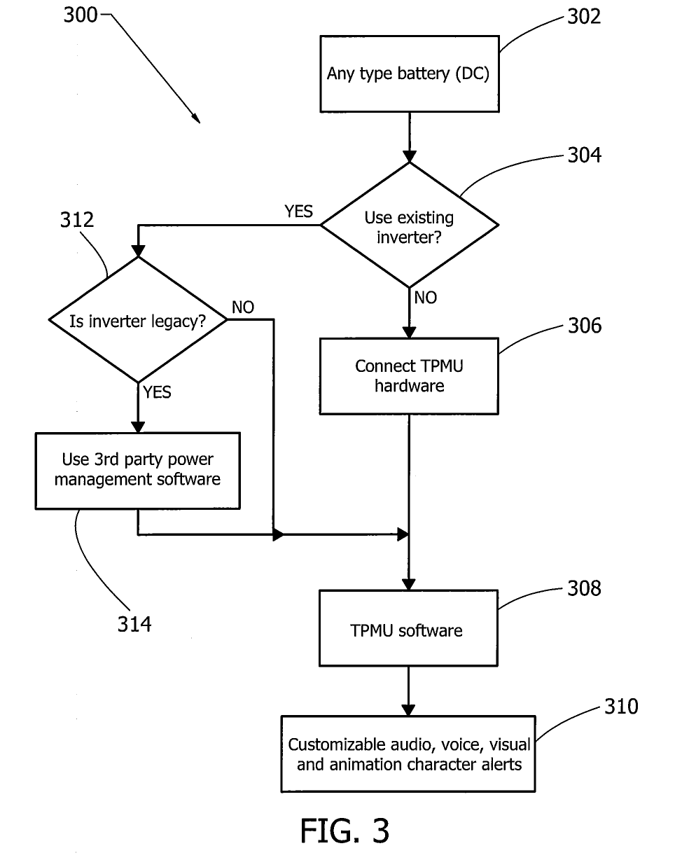

FIG. 3 illustrates a technical flowchart of the system 300 for monitoring remaining battery charge levels and detecting when battery charge levels are low. At 302, any type of battery is recognized from either a stationary or a mobile device requiring power management. Then at 304, it is determined whether to use an existing inverter in the device to collect the remaining Battery Charge (RBC) and power source (i.e., battery or alternating current (AC)) information. If an existing inverter is not used, then at 306 TPMU hardware is directly brought into communication with the battery to monitor the battery charge levels and trigger the message alert. The hardware comprises a microchip programmed with a software program which monitors the battery levels and triggers message alerts. Once the TPMU hardware is brought in the software program programmed in the microchip comprises firmware that communicates with the stationary or the mobile device to capture specific battery charge levels and trigger a message alert. At 308, TPMU software triggers the alerts based on battery threshold levels. The software also detects the usage of the device by tracking keyboard and/or mouse clicks. The software also places the device into standby mode when not in use saving battery power and wakes up the device when the device is activated for use. At 310, the alert will be played in any customizable format as decided by the user which include, but are not limited to, audio voice, visual, animated character. Audio alerts are played via the speaker on the device or the speaker on the TPMU hardware. Visual and animation characters are displayed or played on the device's screen or the TPMU hardware screen.

If the inverter is needed at 304, then at 312 a check is made to determine if the inverter is a legacy inverter. If the inverter is a legacy inverter, then at 314 a third party power management software is utilized to communicate with the legacy inverter to collect the remaining battery charge (RBC) and power source (i.e., battery or alternating current (AC)) information. At 308, TPMU software triggers the alerts based on battery threshold levels. At 310, the alert will be played in any customizable format as decided by the user which include, but are not limited to, audio voice, visual, animated character. Audio alerts are played via the speaker on the device or the speaker on the TPMU hardware. Visual and animation characters are displayed or played on the device's screen or the TPMU hardware screen.

If the inverter is NOT a legacy type at 312, then at 308, TPMU software communicates with the inverter directly to trigger the alerts based on battery threshold levels. At 310, if a low battery charge level and/or a predetermined threshold level has been met, a customizable message alert is sent to a user. The message alert can be audio message alerts, video message alerts, or both audio and video message alerts. For example, the message alerts are customizable audio/voice alerts with or without animated characters. Visual and animation characters are displayed or played on the device's screen or the TPMU hardware screen.

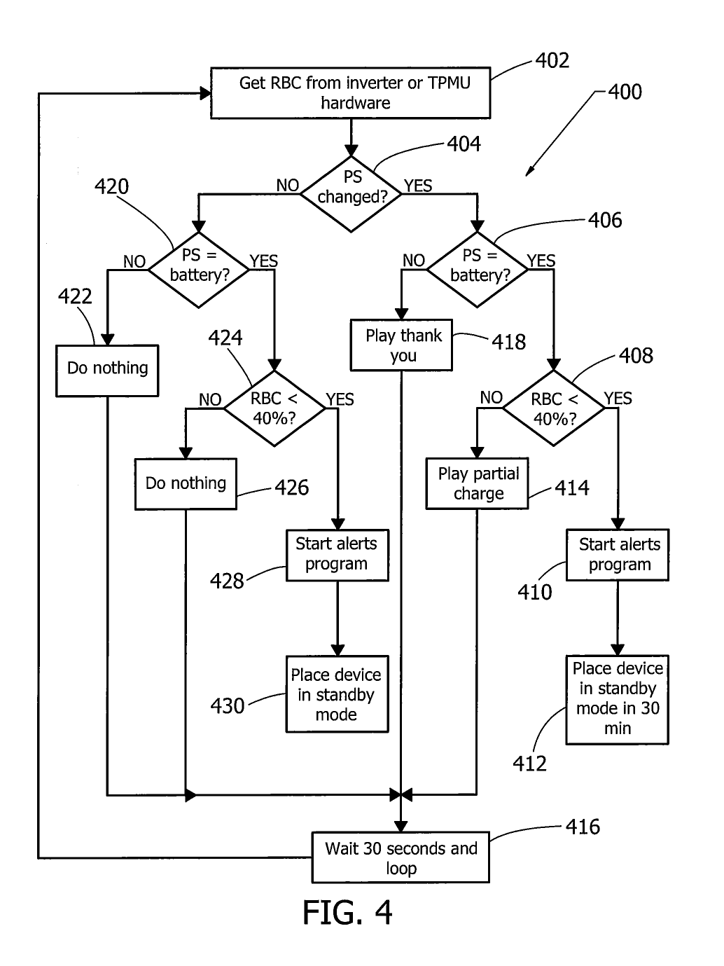

FIG. 4 illustrates a software flowchart of the system 400 for monitoring remaining battery charge levels and detecting when battery charge levels are low. At 402, any type of battery is recognized from either a stationary or a mobile device requiring power management. The remaining battery capacity (RBC) of the device is then acquired from an inverter or from the TPMU hardware. At 404, it is determined whether the power source (PS) (i.e., a battery or AC) of the device has been changed by the user by physically plugging or unplugging the device to or from an electrical outlet or if there is a power outage or a power restore. If the power source has been changed, then at 406 it is determined if the power source is a battery. If the power source is not a battery, (i.e., its AC) then, at 418 the user is complimented for plugging the device into an electrical outlet. The compliment is done by playing a customizable audio, voice message depending on whether the action was performed by a user or by an automatic power restore. Then at 416, the software waits approximately thirty seconds and loops back to repeat the process.

If at 406, the power source is changed to a battery (unplug event or power outage event), then at 408 it is determined if the remaining battery capacity (RBC) is less than 40%. If the RBC is less than 40%, then at 410 the Alert Program is started and a customizable audio voice and/or visual message alert is sent to a user. At 412, the device is placed into standby mode automatically in approximately thirty minutes. Specifically, once an alert has been sent to a user, a predetermined period of time passes (i.e., approximately thirty minutes), and then the device is automatically placed into standby mode. During this 30 minute alert period, a sequence of alerts at regular intervals are played or displayed to the user. These alerts include, but are not limited to, audio voice, visual, animated character and are fully customizable by the user.

If at 408, the RBC is greater than or equal to 40%, then the user has physically unplugged the device from an electrical outlet or there was a power outage. At 414, an alert is then sent to the user with a warning message that the device is only partially charged. These alerts include, but are not limited to, audio voice, visual, animated character and are fully customizable by the user. Then at 416, the software waits approximately thirty seconds and loops back to repeat the process.

As stated supra at 402, the remaining battery capacity (RBC) of the device is acquired from an inverter or from TPMU hardware. At 404, it is determined whether the power source (PS) (i.e., a battery or AC) of the device has been changed by the user by physically plugging or unplugging the device to or from an electrical outlet or if there is a power outage or a power restore. If the power source has not been changed (i.e., after waiting 30 seconds at 416, the power source battery or AC remain the same as before), then at 420 it is determined if the power source is a battery. If the power source is not a battery, then at 422 the software does nothing since there is no change in power source and continues as before. Then at 416, the software waits approximately thirty seconds and loops back to repeat the process.

If at 420, the power source is a battery, then at 424 it is determined if the remaining battery capacity (RBC) is less than 40%. If the RBC is greater than or equal to 40%, then at 426 the software does nothing. Then at 416, the software waits approximately thirty seconds and loops back to repeat the process.

If at 424, the RBC is less than 40% then, at 428 the Alert Program is started and a customizable message alert is sent to a user for a continuous period of 30 minutes. These alerts include, but are not limited to, audio voice, visual, animated character and are fully customizable by the user. At 430, the device is placed in standby mode automatically in approximately thirty minutes. Specifically, once an alert has been sent to a user, a predetermined period of time passes with frequent alerts (i.e., approximately thirty minutes), and then the device is automatically placed in standby mode. The predetermined period of time can be factory set or customizable by the user.

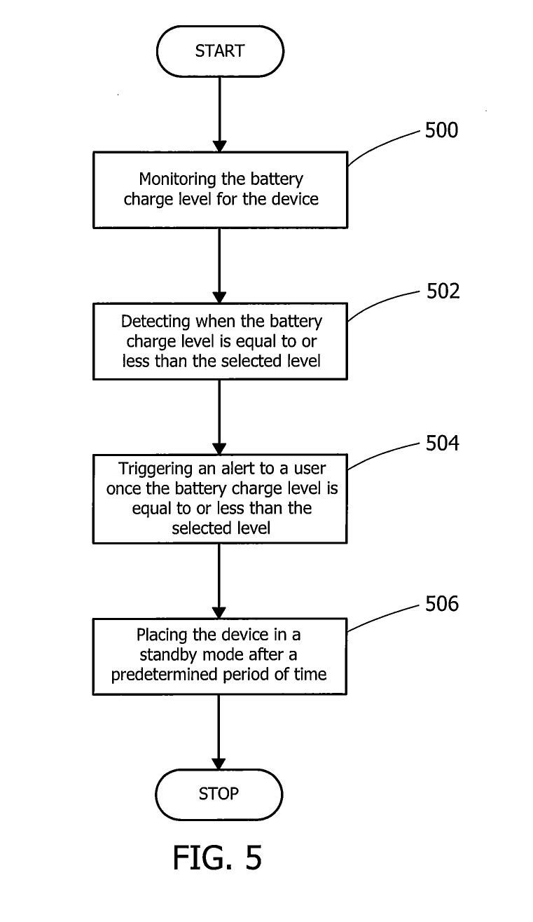

FIG. 5 illustrates a computer-implemented method for monitoring a remaining battery charge level in a device and detecting when said battery charge level is reduced to a selected level, according to various aspects of the innovation. While, for purposes of simplicity of explanation, the one or more methodologies shown herein (e.g., in the form of a flow chart or flow diagram) are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

Referring to FIG. 5, a method for monitoring a remaining battery charge level in a device and detecting when said battery charge level is reduced to a selected level is illustrated. Typically, a device that requires power management is utilized. At 500, remaining battery charge levels for the device are monitored by the inverter if one already exists in the device and/or by the TPMU hardware. At 502, battery charge levels that are equal to or less than the selected level are detected by the TPMU software program. Specifically, a software program can be utilized to monitor the battery charge levels and trigger a message alert. The software program comprises middle ware that communicates with the device to capture specific battery charge levels and trigger the message alert. Alternatively, or in addition to, hardware can be utilized to monitor the battery charge levels and trigger the message alert. The hardware comprises a microchip programmed with a software program which monitors the battery levels and triggers message alerts.

At 504, once the battery charge level is equal to or less than the selected level, an alert is triggered to a user by the TPMU software using the device's speakers or via the TPMU hardware which includes a micro-speaker. Specifically, if the battery charge level is equal to or less than the selected level, a customizable message alert is sent to a user. The message alert can be audio message alerts, video message alerts, or both audio and video message alerts. For example, the message alerts are customizable audio/voice alerts with or without animated characters. At 506, the device enters a standby mode after a predetermined period of time. Typically, once an alert is sent to a user, a predetermined period of time passes and then the device is automatically placed into a standby mode. The predetermined period of time can be factory set or customizable by the user.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical, solid state, and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

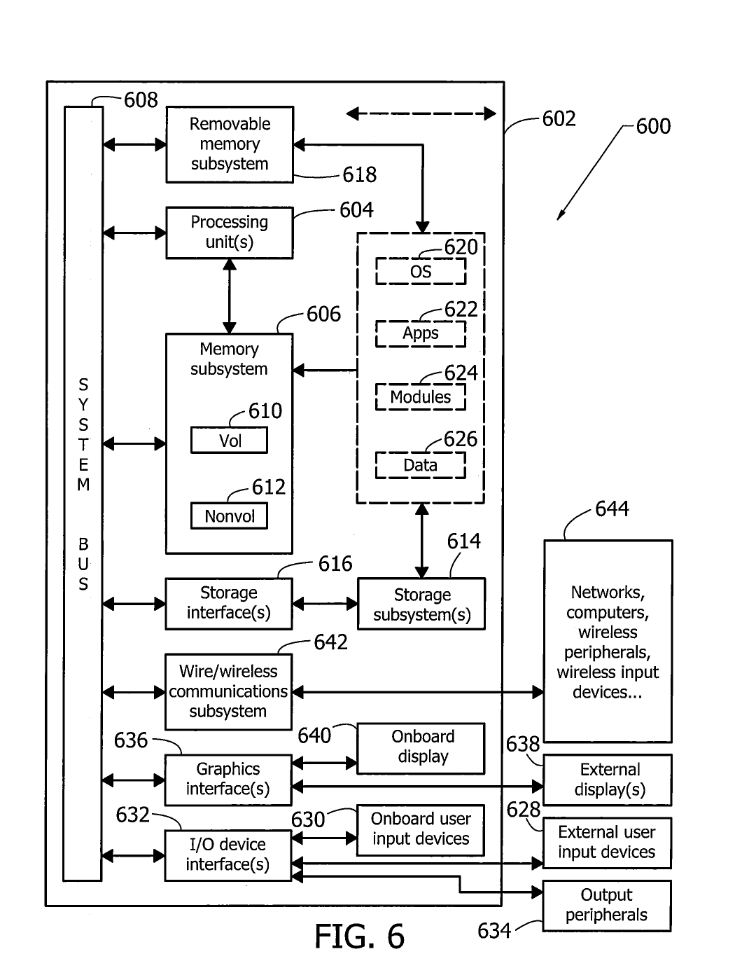

Referring now to FIG. 6, there is illustrated a block diagram of a computing system 600 operable to execute the monitoring and detecting system in accordance with the disclosed architecture. In order to provide additional context for various aspects thereof, FIG. 6 and the following discussion are intended to provide a brief, general description of the suitable computing system 600 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 600 for implementing various aspects includes the computer 602 having processing unit(s) 604, a system memory 606, and a system bus 608. The processing unit(s) 604 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, tablets, microprocessor-based or programmable consumer electronics, and the like, each of which can be operatively coupled to one or more associated devices.

The system memory 606 can include volatile (VOL) memory 610 (e.g., random access memory (RAM)) and non-volatile memory (NON-VOL) 612 (e.g., ROM, EPROM, EEPROM, etc.). A basic input/output system (BIOS) can be stored in the non-volatile memory 612, and includes the basic routines that facilitate the communication of data and signals between components within the computer 602, such as during startup. The volatile memory 610 can also include a high-speed RAM such as static RAM for caching data.

The system bus 608 provides an interface for system components including, but not limited to, the memory subsystem 606 to the processing unit(s) 604. The system bus 608 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 602 further includes storage subsystem(s) 614 and storage interface(s) 616 for interfacing the storage subsystem(s) 614 to the system bus 608 and other desired computer components. The storage subsystem(s) 614 can include one or more of a hard disk drive (HDD), a magnetic floppy disk drive (FDD), and/or optical disk storage drive (e.g., a CD-ROM drive DVD drive), for example. The storage interface(s) 616 can include interface technologies such as EIDE, ATA, SATA, and IEEE 1384, for example.

One or more programs and data can be stored in the memory subsystem 606, a removable memory subsystem 618 (e.g., flash drive form factor technology), and/or the storage subsystem(s) 614 (e.g., optical, magnetic, solid state), including an operating system 620, one or more application programs 622, other program modules 624, and program data 626.

The aforementioned application programs 622, program modules 624, and program data 626 can include the computer-implemented system 100 of FIG. 1, including the monitoring component 102, the detection component 104, the trigger component 106, and the power component 108, and, the entities and components and arrangement of system 200 of FIG. 2, system 300 of FIG. 3, and system 400 of FIG. 4. The aforementioned application programs 622, program modules 624, and program data 626 can also include the methods represented by the flow chart of FIG. 5, for example.

Generally, programs include routines, methods, data structures, other software components, etc., that perform particular tasks or implement particular abstract data types. All or portions of the operating system 620, applications 622, modules 624, and/or data 626 can also be cached in memory such as the volatile memory 610, for example. It is to be appreciated that the disclosed architecture can be implemented with various commercially available operating systems or combinations of operating systems (e.g., as virtual machines).

The storage subsystem(s) 614 and memory subsystems (606 and 618) serve as computer readable media for volatile and non-volatile storage of data, data structures, computer-executable instructions, and so forth. Computer readable media can be any available media that can be accessed by the computer 602 and includes volatile and non-volatile media, removable and non-removable media. For the computer 602, the media accommodates the storage of data in any suitable digital format. It should be appreciated by those skilled in the art that other types of computer readable media can be employed such as zip drives, magnetic tape, flash memory cards, cartridges, and the like, for storing computer executable instructions for performing the novel methods of the disclosed architecture.

A user can interact with the computer 602, programs, and data using external user input devices 628 such as a keyboard and a mouse. Other external user input devices 628 can include a microphone, an IR (infrared) remote control, a joystick, a game pad, camera recognition systems, a stylus pen, touch screen, gesture systems (e.g., eye movement, head movement, etc.), and/or the like. The user can interact with the computer 602, programs, and data using onboard user input devices 630 such a touchpad, microphone, keyboard, etc., where the computer 602 is a portable computer, for example. These and other input devices are connected to the processing unit(s) 604 through input/output (I/O) device interface(s) 632 via the system bus 608, but can be connected by other interfaces such as a parallel port, IEEE 1384 serial port, a game port, a USB port, an IR interface, etc. The I/O device interface(s) 632 also facilitate the use of output peripherals 634 such as printers, audio devices, camera devices, and so on, such as a sound card and/or onboard audio processing capability.

One or more graphics interface(s) 636 (also commonly referred to as a graphics processing unit (GPU)) provide graphics and video signals between the computer 602 and external display(s) 638 (e.g., LCD, plasma) and/or onboard displays 640 (e.g., for portable computer). The graphics interface(s) 636 can also be manufactured as part of the computer system board.

The computer 602 can operate in a networked environment (e.g., IP) using logical connections via a wired/wireless communications subsystem 642 to one or more networks and/or other computers. The other computers can include workstations, servers, routers, personal computers, microprocessor-based entertainment appliance, a peer device or other common network node, and typically include many or all of the elements described relative to the computer 602. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet. Further, the software framework system can operate over the Internet in an Application Service Provider (ASP) environment, wherein the system is hosted at a data center and a user logs-in via a secure connection over the Internet.

When used in a networking environment the computer 602 connects to the network via a wired/wireless communication subsystem 642 (e.g., a network interface adapter, onboard transceiver subsystem, etc.) to communicate with wired/wireless networks, wired/wireless printers, wired/wireless input devices 644, and so on. The computer 602 can include a modem or has other means for establishing communications over the network. In a networked environment, programs and data relative to the computer 602 can be stored in the remote memory/storage device, as is associated with a distributed system. It will be appreciated that the network connections shown are exemplary and other means of establishing a communications link between the computers can be used.

The computer 602 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

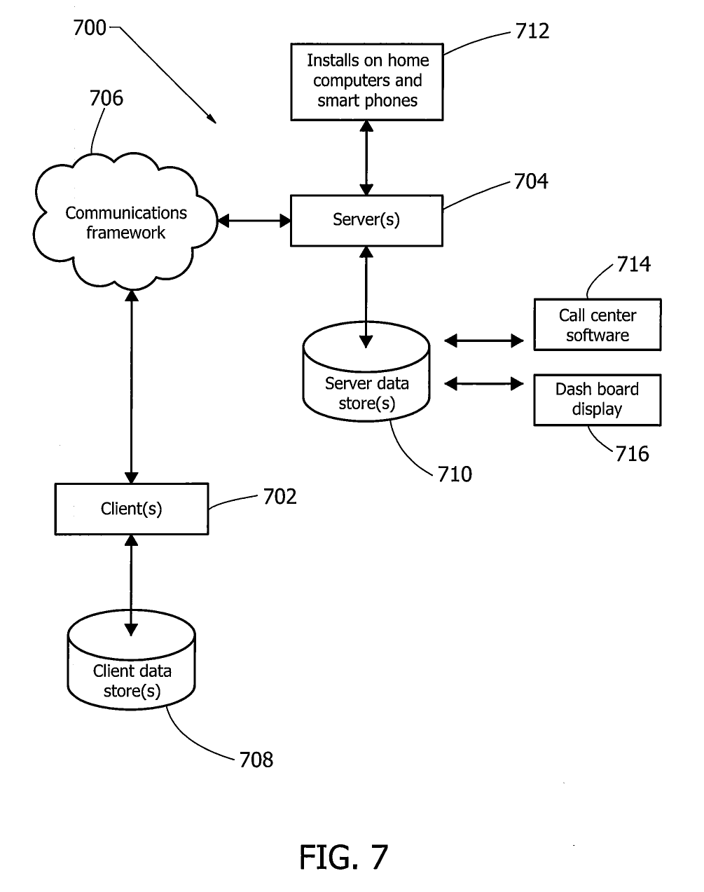

Referring now to FIG. 7, there is illustrated a schematic block diagram of a computing environment 700 operable to provide support for the software framework. Specifically, FIG. 7 shows the schematic block diagram of the complete solution involving the server, client communication. The environment 700 includes one or more client(s) 702. The client(s) 702 can be hardware and/or software (e.g., threads, processes, computing devices). The client(s) 702 can house cookie(s) and/or associated contextual information, for example.

The environment 700 also includes one or more server(s) 704. The server(s) 704 can also be hardware and/or software (e.g., threads, processes, computing devices). The servers 704 can house threads to perform transformations by employing the architecture, for example. One possible communication between a client 702 and a server 704 can be in the form of a data packet adapted to be transmitted between two or more computer processes. The data packet may include a cookie and/or associated contextual information, for example. The environment 700 includes a communication framework 706 (e.g., a global communication network such as the Internet) that can be employed to facilitate communications between the client(s) 702 and the server(s) 704.

Communications can be facilitated via a wire (including optical fiber) and/or wireless technology. The client(s) 702 are operatively connected to one or more client data store(s) 708 that can be employed to store information local to the client(s) 702 (e.g., cookie(s) and/or associated contextual information). Similarly, the server(s) 704 are operatively connected to one or more server data store(s) 710 that can be employed to store information local to the servers 704.

Furthermore, the TPMU software is designed to work on a single stand-alone device for a home user or a business user (see 712). The software is also designed to work on an iPhone or other smart phone (see 712). If the software is implemented in a business or corporation on multiple devices a “TPMU Server Software” is developed which then installs on a Windows server using SQL server as the database. All the client devices communicate with the server to send and receive data for installation, configuration, customization, patching, reporting purposes and also to maintain licenses.

Additionally, the software can be independent of a server requirement after the initial install for home or phone users. This software will manage power on a user's mobile devices via audio voice, visual and animated character alerts. Further, the server solution will interface with any call center software 714 to open tickets or send alerts to pagers automatically when a specific criteria is met on the device, alerting support staff of problems. And, the dashboard display 716 allows for a single dashboard view of all devices being managed via this solution, by geographical area. The dashboard display 716 shows each device by its device name with color coded alerts giving support staff a visual of device usage, current battery levels and/or problem devices that need attention.

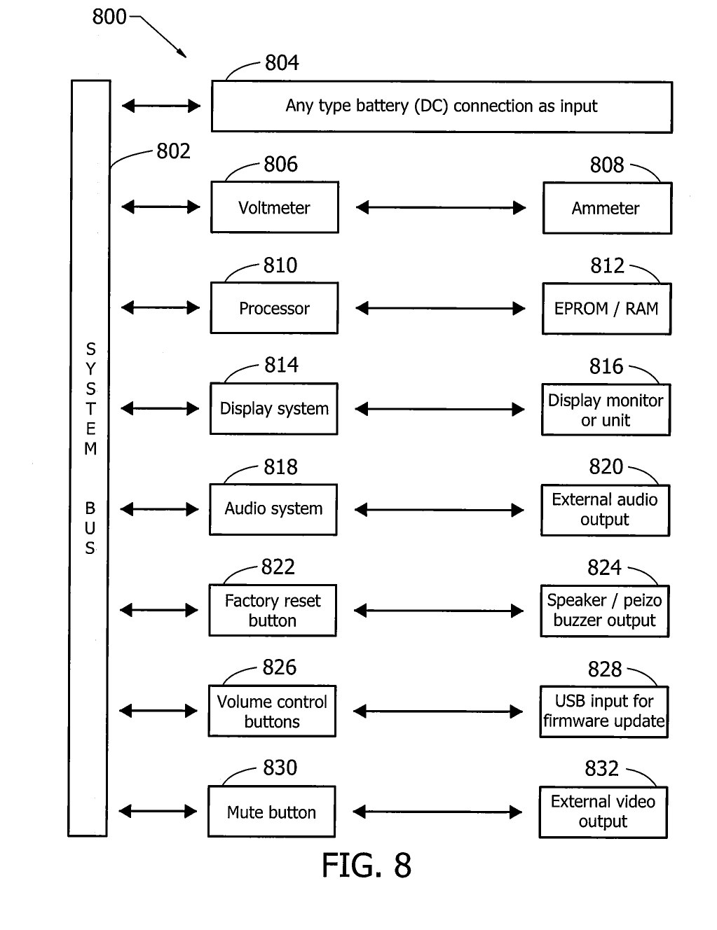

FIG. 8 illustrates a TPMU hardware block diagram of the system 800 for monitoring remaining battery charge levels and detecting when battery charge levels are low. The system 800 is the block diagram of the TPMU hardware that is used with mobile and stationary devices to enable them to receive the battery charge levels and produce alerts. The alerts include, but are not limited to, audio voice, visual and/or animated characters. System bus 802 is the connection wiring between all the hardware components on the system board of the TPMU hardware. All signals, commands, instructions, input and output goes through the system bus 802. At 804, any type of battery (DC) can be connected to the system board via the cables and connectors. The voltmeter 806 is the part of the electronics that measures the voltage in Volts in the battery. This voltage value will be used as a part of input to calculate the remaining battery capacity (RBC). The ammeter 808 is the part of the electronics that measures the current in Amperes in the battery. This current value will be used as a part of the input to calculate the remaining battery capacity (RBC).

Processor 810 is used to calculate the remaining battery charge (RBC) based on the input from the voltmeter 806 and ammeter 808. Processor 810 also performs a variety of functions which include, but are not limited to, executing the program stored in EPROM, taking input from other blocks like USB input, factory reset, volume control, mute buttons, process the input and send commands and output to various blocks like speaker, external audio, display monitor etc. EPROM/RAM 812 (Erasable Programmable Read Only Memory/Random Access Memory) will store the TPMU software application which does the complete monitoring, detection and alerting functionalities. The RAM (Random Access Memory) is used to store the program and intermediate results and provide them to the processor at a faster pace. Display System 814 converts the output from the processor 810 to a format that the video display unit will be able to display properly. Display Monitor/Unit 816 is the physical display unit. It can be an internal or external display depending on the device. It will display the visual messages and/or play animation characters.

Audio System 818 converts the output from the processor 810 to a format that the audio unit will be able to send sound to speakers or a peizo buzzer. External Audio Output 820 sends the alert sounds to external speakers if desired. Factory Reset Button 822, when pressed for 10 seconds, will erase all the custom-made configuration settings and will reset the device to factory defaults. At 824, the audio sound from the audio system 818 is sent out to the attached speaker or peizo buzzer. Volume Control Buttons 826 allow users to increase and decrease volume on the unit. USB input for firmware update port 828, allows the user to download the latest firmware from the Internet to keep the device up-to-date with new features and bug fixes. Mute Button 830 silences the speakers for a specified period of time configurable by the user. External video output 832 displays alerts on an external monitor. The output is via HDMI and DVI.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented method for monitoring a remaining battery charge level in a device and detecting when said battery charge level is reduced to a selected level, using a processor coupled to a memory, comprising:
monitoring the battery charge level for the device;
detecting when the battery charge level is equal to or less than the selected level; and
triggering an alert to a user once the battery charge level is equal to or less than the selected level.

2. The computer-implemented method of claim 1, wherein the monitoring of the battery charge level for the device comprises utilizing software to monitor the battery charge level and trigger the alert.

3. The computer-implemented method of claim 2, wherein the software comprises a middle ware that communicates with the device to capture a selected battery charge level and trigger the alert.

4. The computer-implemented method of claim 1, wherein the monitoring of the battery charge level for the device comprises utilizing hardware to monitor the battery charge level and trigger the alert.

5. The computer-implemented method of claim 4, wherein the hardware comprises a microchip programmed with software to monitor the battery charge level and trigger the alert.

6. The computer-implemented method of claim 1, wherein the alert is customizable by a user.

7. The computer-implemented method of claim 6, wherein the alert is an audio alert.

8. The computer-implemented method of claim 6, wherein the alert is a video alert and comprises an animated character.

9. The computer-implemented method of claim 6, wherein the alert is both an audio and a video alert.

10. The computer-implemented method of claim 1, further comprising placing the device in a standby mode after a predetermined period of time.

11. A computer-implemented system for monitoring a remaining battery charge level in a device and detecting when said battery charge level is reduced to a selected level, comprising:
a monitoring component that monitors the battery charge level for the device;
a detection component that detects when the battery charge level is equal to or less than the selected level; and
a trigger component that sends an alert to a user once the battery charge level is equal to or less than the selected level.

12. The computer-implemented system of claim 11, further comprising a power component that places the device in a standby mode after a predetermined period of time.

13. The computer-implemented system of claim 11, wherein the monitoring component and the detection component comprises software and middle ware that communicates with the device to capture a selected battery charge level and trigger the alert.

14. The computer-implemented system of claim 11, wherein the monitoring component and the detection component comprises hardware that comprises a microchip programmed with software to monitor the battery charge level and trigger the alert.

15. The computer-implemented system of claim 11, wherein the power component places the device into standby mode automatically based on a specific battery charge level when the device is not in use and wherein the power component wakes up the device when the device is activated for use.

16. The computer-implemented system of claim 15, wherein the alert is an audio alert.

17. The computer-implemented system of claim 15, wherein the alert is a video alert.

18. The computer-implemented system of claim 15, wherein the alert is both an audio and a video alert.

19. The computer-implemented system of claim 13, wherein reports run by the software can be displayed on a dashboard.

20. A system for monitoring a remaining battery charge level in a device and detecting when said battery charge level is reduced to a selected level, comprising:
a monitoring component that monitors the battery charge level for the device;
a detection component that detects when the battery charge level is equal to or less than the selected level;
a trigger component that sends an alert to a user once the battery charge level is equal to or less than the selected level; and
a power component that places the device in a standby mode after a predetermined period of time; and
wherein the monitoring component and the detection component comprises customizable software that communicates with the device to capture a specific battery charge level and trigger the alert.
